(19) United States
(12) Patent Application Publication
(10) Pub. No.: US 2007/0128429 A1
(43) Pub. Date: Jun. 7, 2007

(54) Safety Mat

(76) Inventor: Michael Murphy, Winona, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/275,018

(22) Filed: Dec. 1, 2005

(51) Int. Cl. B32B 27/00

(52) U.S. Cl. 428/319.3; 428/71; 428/76; 428/319.7

(57) ABSTRACT

A device and method for protecting objects or people from damage is shown. In one example, a floor mat is designed to absorb impact forces and reduce injury of persons falling from a bed in a heath care environment. Design features are shown that protect the human body from the forces of a patient falling in addition to features that allow a thin and user friendly mat.

### TECHNICAL FIELD

This invention relates to devices and methods for a mat to prevent damage as a result of striking a hard surface. In one specific example, this invention relates to cushioning mats for protection against injury in the event of a fall to the floor.

### BACKGROUND

Safety mats are useful to prevent damage from hard surfaces, for example, people falling onto a hard surface such as a floor. Thousands of people each year suffer serious injury or death as a result of simply falling from their beds in healthcare institutions. The force and impact from even an 18 inch drop is enough to cause fractures and other life threatening trauma. Many nursing homes are now being required to implement restraint free care. For example, side rails once used to prevent falls from beds are being phased out. Care providers are in need of devices that will prevent or minimize injury if a fall occurs. However, mats that provide sufficient protection are often bulky and cumbersome.

What is needed is a safety mat that is both effective at impact absorption and operational friendly to the day to day activities of a health care institution

### BRIEF DESCRIPTION OF THE DRAWINGS

FIG. 1 shows a top view photograph of a safety mat according to an embodiment of the invention.

FIG. 2 shows a bottom view photograph of a safety mat according to an embodiment of the invention.

FIG. 3 shows a side view photograph of a safety mat according to an embodiment of the invention with a corner cut away to reveal interior detail.

FIG. 4A shows a side view diagram of a safety mat according to an embodiment of the invention.

FIG. 4B shows another side view diagram of a safety mat during impact according to an embodiment of the invention.

FIG. 5 shows a flow diagram of method of forming a safety mat according to an embodiment of the invention.

### DETAILED DESCRIPTION

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, or logical changes, etc. may be made without departing from the scope of the present invention.

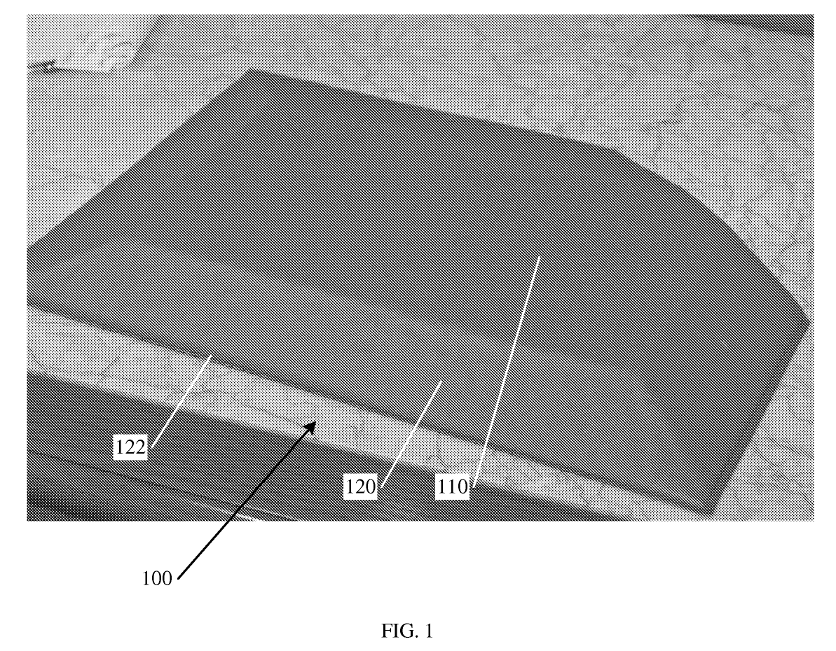

FIG. 1 shows a safety mat 100 according to an embodiment of the invention. The safety mat 100 includes a main body portion 110 and tapered edge portions 120. A perimeter 122 of the safety mat 100 is shown at an outermost portion of the tapered edge portions 120. The safety mat 100 is shown in a rectangular configuration, however the invention is not so limited. Other geometries, circles, squares, etc. are within the scope of the invention. In one embodiment, a more complex shape such as a “C” or an “L” shape is used. In one embodiment, a shape of the safety mat 100 is designed to fit around a hospital bed.

Although the safety mat 100 example discussed is adapted to protect a falling human from a floor surface, the invention is not so limited. Other hard surfaces such as walls, etc. can be protected using embodiments described below, and further, other fragile objects can be protected from hard surfaces in addition to protecting people.

As shown in FIG. 1, in one embodiment, at least one edge of the safety mat 100 includes a tapered edge portion 120. One advantage of a tapered edge portion 120 includes a reduced tendency to catch a walking person's toe and cause a fall. Another advantage of a tapered edge portion 120 includes improved ability for wheeled devices such as wheel chairs, or wheeled carts to navigate over the safety mat 100. In one embodiment, all edges of the safety mat 100 include a tapered edge portion 120. In one embodiment, a taper rises approximately one inch over three inches of lateral space.

In one embodiment, as shown in FIG. 1, the safety mat 100 is formed in an substantially continuous unit. Alternative embodiments may include multiple panels separated by a thinner, more flexible joint for folding, etc. One advantage of a continuous unit includes a smoother, more stable surface with fewer ridges that may cause tripping. Another advantage of a continuous unit includes removal of possible weak spots in the surface where there is less padding to protect a falling object or person.

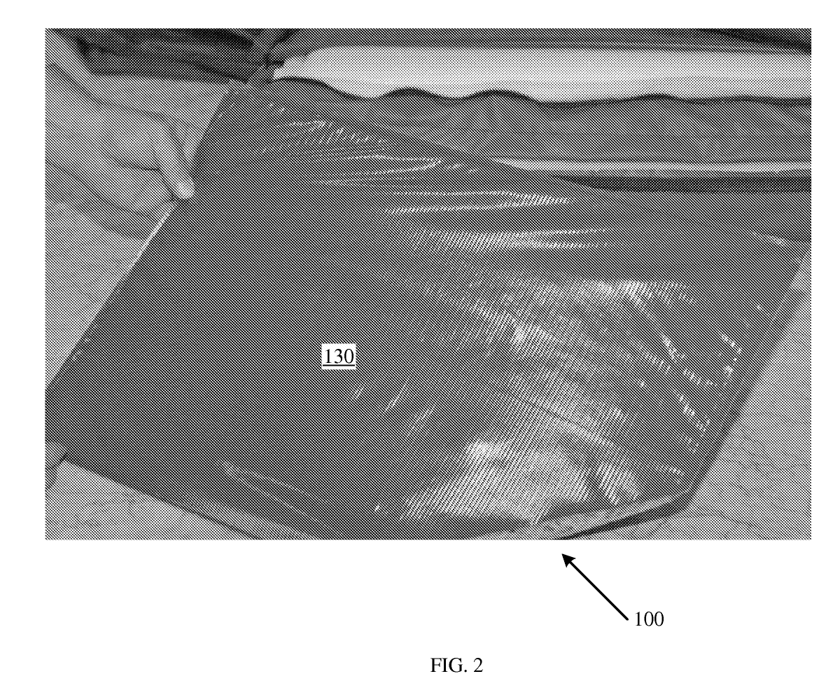

FIG. 2 shows a bottom surface 130 of the safety mat 100. In one embodiment, the bottom surface 130 includes a high coefficient of friction material to reduce sliding of the safety mat. In one embodiment, the bottom surface 130 includes a rubberized material. In one embodiment, the bottom surface 130 includes rubberized vinyl fabric. An advantage of rubberized vinyl fabric includes high durability, high coefficient of friction with a number of adjoining surfaces, and high flexibility. Rubberized vinyl fabric also exhibits low permeability to air flow through the fabric. This provides certain advantages that will be discussed in more detail below.

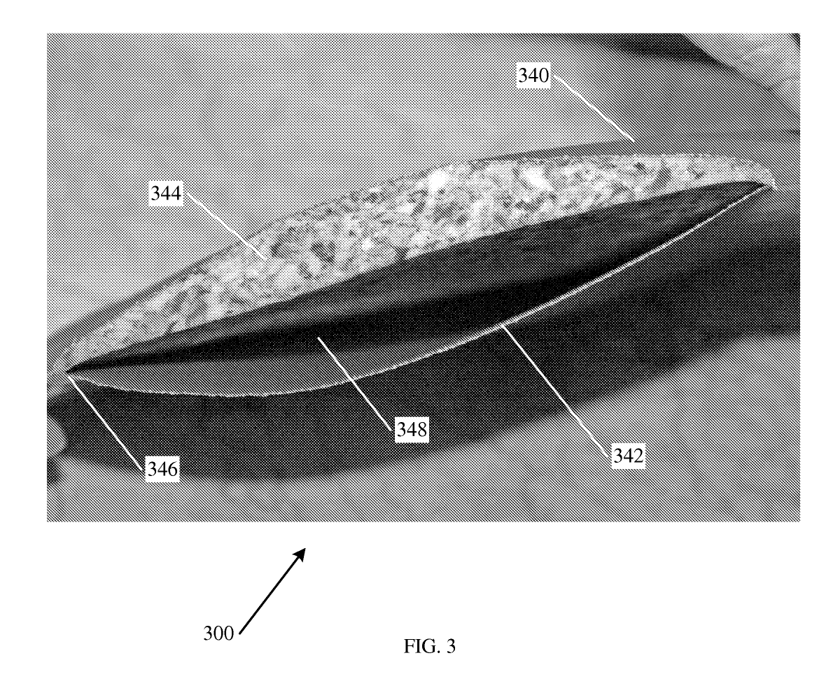

FIG. 3 shows a cutaway section of an embodiment of a safety mat 300 similar to embodiments discussed above. The safety mat 300 includes a first outer layer 340 and a second outer layer 342. A layer of deformable material 344 is shown located between the first outer layer 340 and the second outer layer 342. In one embodiment, the deformable material 344 includes a foamed material, such as a foamed polymer. Although foam is shown, other force absorbing or deformable materials are within the scope of the invention.

In one embodiment, the layer of deformable material 344 includes a re-bonded foam composite material. One advantage of a re-bonded foam composite material includes reduced cost. Such materials can be formed from recycled foams. Another advantage of a re-bonded foam composite material includes the ability to create a specific modulus of elasticity by re-bonding various volume fractions of different foams. The resulting re-bonded foam modulus will be a combination of the elastic properties of the various foams used. In one embodiment, the deformable material has a density in a range between approximately 7 pounds per cubic foot, to approximately 10 pounds per cubic foot. In one embodiment, a higher foam density is chosen to dissipate impact force over a longer period of time, however the foam density is chosen low enough to deform upon impact. High density foam also allows for a thinner mat that is less likely to be a tripping hazard.

In one embodiment, the second outer layer 342 includes a high coefficient of friction material similar to the materials discussed above. In one embodiment, the second outer layer 342 includes rubberized vinyl fabric. In one embodiment, the first outer layer 340 includes a high durability material. One example of a high durability material includes nylon reinforced vinyl. In one embodiment, the first outer layer includes a specific color and/or pattern choice that is desirable in elder care environments. In one embodiment a light colored and/or faded color and pattern is used for the first outer layer 340. Persons in an elder care environment with certain afflictions such as Alzheimer's, Parkinson's or dementia can respond negatively to saturated colors such as royal blue. In many cases, such persons view saturated colors as barriers or black holes. They can become agitated or avoid the item completely, possible resulting in injury. Some examples of colors and/or patterns that elder care patients tend to respond well to include faded gray colors or faded green colors.

FIG. 3 shows the first outer layer 340 attached to the second outer layer 342 at a perimeter 346. In one embodiment, the first outer layer 340 is attached to the second outer layer 342 using a heat sealing process. One advantage of a heat sealed edge includes ease of manufacturability in contrast to, for example folding and gluing the perimeter. Another advantage of a heat sealed edge includes a reliable air tight, or low air permeability joint between the first outer layer 340 and the second outer layer 342.

The layer of deformable material 344 is shown attached at an interface with the first outer layer 340. In one embodiment, the layer of deformable material 344 is laminated to the first outer layer 340. In contrast, the layer of deformable material 344 is shown unattached to the second outer layer 342 in an area that is within the perimeter 346. In the particular orientation of the safety mat 300 shown in FIG. 3, an air pocket 348 is possible within the safety mat 300. In one embodiment, the first outer layer 340 serves as a top surface of the safety mat 300, and the second outer layer 342 serves as a bottom surface. The possible air pocket 348 is therefore located below the layer of deformable material 344. In another embodiment, the first outer layer 340 serves as a bottom surface of the safety mat 300, and the second outer layer 342 serves as a top surface with the air pocket 348 being located above the layer of deformable material 344. One advantage to having the laminated first outer layer 340 as a top surface includes improved stability for persons walking over the mat 300.

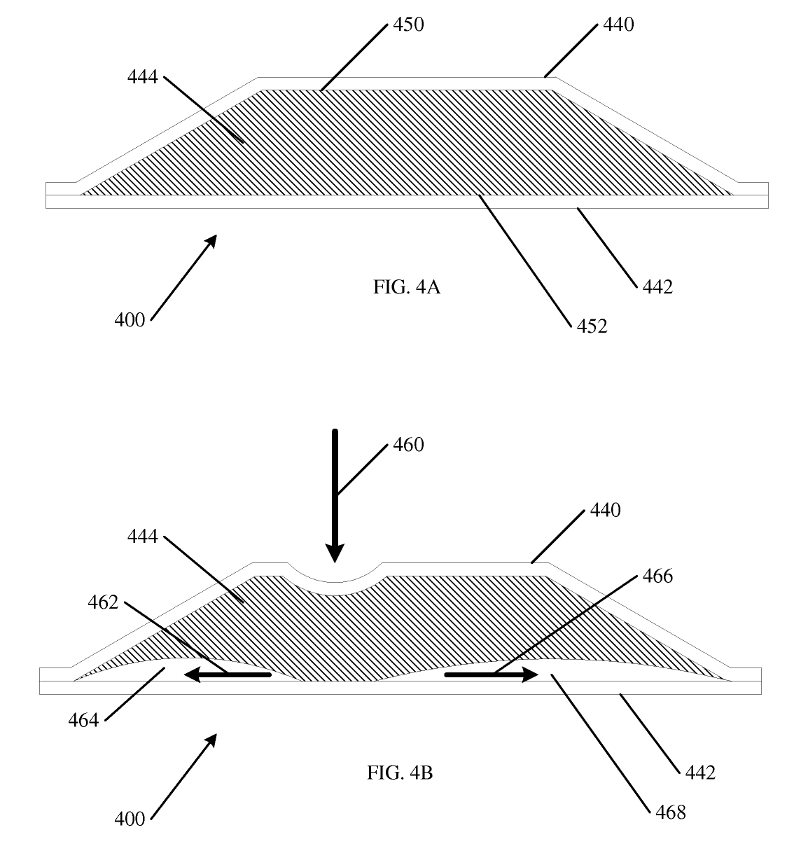

FIG. 4A shows a diagram of a cross section of a safety mat 400 similar to embodiments discussed above. A first outer layer 440 is shown with a second outer layer 442. A layer of deformable material 444 is located between the first outer layer 440 and the second outer layer 442. As described above, in one embodiment, a first interface 450 is substantially attached between the first outer layer 440 and the layer of deformable material 444. In one embodiment, a second interface 452 is substantially unattached within a perimeter of the safety mat 400.

One advantage of interface configurations described above is shown in FIG. 4B. Embodiments of safety mats described provide a significant increase in force dissipation compared to other conventional safety mat designs. In operation, a force is shown by arrow 460 that represents an object or person falling onto the safety mat 400. Safety mat embodiments described in the present disclosure provide significant force absorbing properties in addition to inherent force absorbing properties of the layer of deformable material 444. In one embodiment, air or some other fluid trapped inside the safety mat 400 between the first outer layer 440 and the second outer layer 442 is allowed to deform the mat 400, creating pockets such as 464 and 468. Movement of the air or other fluid is shown by first arrow 462 and second arrow 466. Because the second outer layer 442 is not attached to the layer of deformable material 444, the pockets such as 464 and 468 provide additional force dissipation from the impact indicated by arrow 460. If the interface is attached, the forces are not dispersed, but reflected back into the impacting object or person.

In one embodiment, forming a low air permeable enclosure or air tight enclosure with the first outer layer 440 and the second outer layer 442 enhances the force dissipating properties of the safety mat 400. Another advantage of a sealed enclosure includes easy cleaning which is important in a health care environment. In one embodiment, the increased force dissipation provided by embodiments described above allows a very thin safety mat. In one embodiment, the safety mat is approximately 1 inch thick or less. An advantage of a thin mat includes further reduction in tripping and further enhancement of ability to used wheeled devices over the safety mat. In one embodiment, an advantage of having the first outer layer 440 laminated to the layer of deformable material 444 includes structural integrity of the safety mat that reduces tripping and facilitated wheeled motion over the safety mat 400.

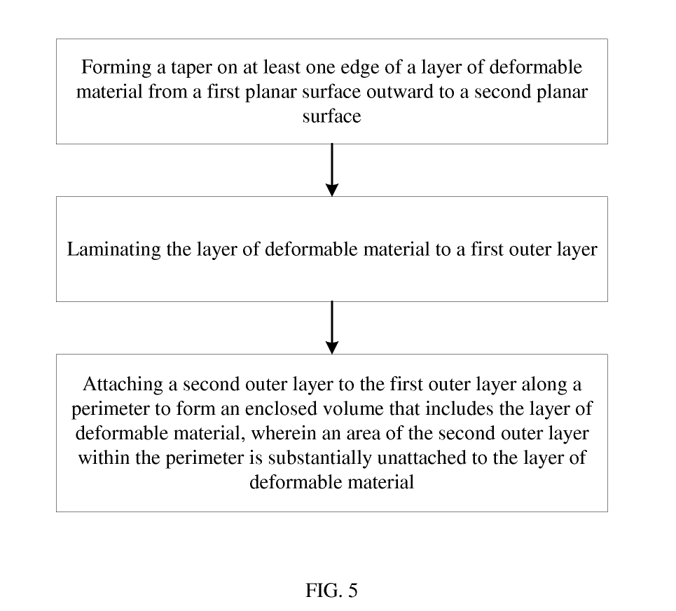

FIG. 5 shows one example of a method of forming a safety mat as described in embodiments above. One operation includes forming a taper on at least one edge of a layer of deformable material from a first planar surface outward to a second planar surface. Another operation includes laminating the layer of deformable material to a first outer layer. In one embodiment, another operation includes attaching a second outer layer to the first outer layer along a perimeter to form an enclosed volume that includes the layer of deformable material, wherein an area of the second outer layer within the perimeter is substantially unattached to the layer of deformable material.

In one embodiment, the operation of attaching a second outer layer to the first outer layer along a perimeter includes heat sealing the second outer layer to the first outer layer. Advantages of such a configuration are described above.

### CONCLUSION

Embodiments of safety mat as described above have a number of advantages. One advantage includes force dissipation inherent in a layer of deformable material in addition to force dissipation at a substantially unlaminated interface. Another advantage includes materials choices to provide safety and durability at a low cost. Another advantage includes tapered edges and structural stability that make the safety mat more usable.

While a number of advantages of embodiments of the invention are described, the above lists are not intended to be exhaustive. Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and methods are used. The scope of the invention should be determined with reference to the appended claims, along with the full scope of equivalents to which such claims are entitled.

I claim:

1. A safety mat, comprising:
a layer of deformable material having a thickness, the layer being attached to a first outer layer;
a second outer layer attached to the first outer layer substantially along a perimeter;
wherein the second outer layer is positioned adjacent to the layer of deformable material and unattached to the layer of deformable material inside the perimeter.

2. The safety mat of claim 1, wherein the thickness is less than or equal to approximately one inch.

3. The safety mat of claim 1, wherein the layer of deformable material includes foam.

4. The safety mat of claim 1, wherein the first outer layer is a top surface layer and the second outer layer is a bottom surface layer.

5. The safety mat of claim 4, wherein the second outer layer includes a rubberized layer.

6. The safety mat of claim 1, wherein the first outer layer is a bottom surface layer and the second outer layer is a top surface layer.

7. A safety mat, comprising:
a top layer;
a surface contact layer coupled to the top layer along a top layer perimeter;
a layer of foam material between the top layer and the surface contact layer, forming a first interface with the top layer and a second interface with the surface contact layer;
wherein the foam material is substantially attached along the first interface, and unattached along the second interface.

8. The safety mat of claim 7, wherein the layer of foam material includes re-bonded composite foam material.

9. The safety mat of claim 7, wherein the top layer includes nylon reinforced vinyl.

10. The safety mat of claim 7, wherein the surface contact layer includes rubberized vinyl fabric.

11. The safety mat of claim 1, wherein the top layer is colored with a non-saturated color.

12. A safety mat, comprising:
a top layer;
a rubberized surface contact layer coupled to the top layer along a top layer perimeter;
a layer of foam material between the top layer and the rubberized surface contact layer, forming a first interface with the top layer and a second interface with the rubberized surface contact layer;
wherein the foam material is substantially attached along the first interface, and unattached along the second interface; and
wherein at least one edge of the mat tapers outwards at an angle from the top layer to the rubberized surface contact layer.

13. The safety mat of claim 12, wherein the layer of foam material includes re-bonded composite foam material.

14. The safety mat of claim 12, wherein the top layer includes nylon reinforced vinyl.

15. The safety mat of claim 12, wherein the foam material includes a density between approximately 7 pounds per cubit foot an approximately 10 pounds per cubic foot.

16. A method of forming a mat, comprising:
forming a taper on at least one edge of a layer of deformable material from a first planar surface outward to a second planar surface;
laminating the layer of deformable material to a first outer layer; and
attaching a second outer layer to the first outer layer along a perimeter to form an enclosed volume that includes the layer of deformable material, wherein an area of the second outer layer within the perimeter is substantially unattached to the layer of deformable material.

17. The method of claim 16, wherein laminating the layer of deformable material to the first outer layer includes laminating the layer of deformable material to a top layer.

18. The method of claim 16, wherein attaching the second outer layer to the first outer layer includes attaching a rubberized layer to a top layer.

19. The method of claim 16, wherein forming the taper on at least one edge of the layer of deformable material includes forming a taper on at least one edge of a foam containing layer.

20. The method of claim 16, wherein attaching a second outer layer to the first outer layer along a perimeter includes heat sealing the second outer layer to the first outer layer.
